(19) United States
(12) Patent Application Publication
(10) Pub. No.: US 2003/0202475 A1
(43) Pub. Date: Oct. 30, 2003

(54) Multiplexing variable-rate data with data services

(76) Inventors: Qingxin Chen, Del Mar, CA (US); Harshwardhan Kulkarni, Encinitas, CA (US); Sriram Nagesh Nookala, San Diego, CA (US)

Correspondence Address: Qualcomm Incorporated, Patents Department, 5775 Morehouse Drive, San Diego, CA, 92121-1714, US

(21) Appl. No.: 10/188,603

(22) Filed: Jul. 2, 2002

Related U.S. Application Data
(60) Provisional application No. 60/375,960, filed on Apr. 25, 2002.

(51) Int. Cl. H04J 3/22; H04L 12/26

(52) U.S. Cl. 370/235; 370/468

(57) ABSTRACT

Techniques for multiplexing variable-rate data with data services on a shared channel are disclosed. In one aspect, data from data services is prioritized. High priority data awaiting transmission may result in a dim command being issued to reduce the rate of the variable-rate data, thus making room for the data services data. Lower priority data from data services may wait for the next available space, without reducing the rate of the variable-rate data. In another aspect, data services data is categorized into three or more priority levels. High priority data can preempt variable-rate data. Medium priority data may result in a dim command reducing the variable-rate data. Low priority data may wait for the next available space, without reducing the rate of the variable-rate data. Various other aspects are also presented. These aspects have the benefit of allowing variable-rate and data services data to be multiplexed on a shared channel, while balancing the quality of the variable-rate data signal and maintaining data services when the variable-rate data is at a high rate.

### RELATED APPLICATIONS

This application claims priority to pending Provisional application No. 60/375,960, filed on Apr. 25, 2002.

### BACKGROUND

Field

The present invention relates generally to communications, and more specifically to a novel and improved method and apparatus for multiplexing variable-rate data with other data services.

Wireless communication systems are widely deployed to provide various types of communication such as voice and data. These systems may be based on Code Division Multiple Access (CDMA), Time Division Multiple Access (TDMA), or some other modulation techniques. A CDMA system provides certain advantages over other types of systems, including increased system capacity.

A CDMA system may be designed to support one or more CDMA standards such as (1) the “TIA/EIA-95-A(B) Mobile Station-Base Station Compatibility Standard for Dual-Mode Wideband Spread Spectrum Cellular System” (the IS-95 standard), (2) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (3) the standard offered by a consortium named “3rd Generation Partnership Project 2” (3GPP2) and embodied in a set of documents including “C.S0002-A Physical Layer Standard for cdma2000 Spread Spectrum Systems,” the “C.S0005-A Upper Layer (Layer 3) Signaling Standard for cdma2000 Spread Spectrum Systems,” and the “C.S0024 cdma2000 High Rate Packet Data Air Interface Specification” (the cdma2000 standard), and (4) some other standards. Non-CDMA systems include the AMPS and GSM systems.

Wireless communication systems may support transmission of variable-rate data. For example, voice signals can be encoded using a vocoder to produce data at variable rates. The rate will be low when the voice activity is low, for example, when the user is listening, and high when voice activity is high, for example, when the user is speaking. Capacity in a wireless communication system can be increased when voice or other variable-rate data is transmitted in such a fashion. Typical CDMA systems inherently benefit from the variable nature of voice data.

Various communication systems also support simultaneous voice (or other variable-rate data) and data services. For example, a user may be talking with a wireless communication device that is also connected to a laptop computer, providing Internet access to the computer. The cdma2000 standard provides for such a feature. In some cases, some or all of the data from the data service must share a channel with variable-rate data, such as voice or video. If the voice activity is high, thus generating a relatively high amount of variable-rate data, and there is packet data awaiting transmission from the data services, data awaiting transmission may exceed the capacity of the shared channel. If voice data is delayed or dropped, there may be a negative effect on voice quality. On the other hand, if data services do not get sufficient bandwidth on the channel, the data service may drop or suffer inadequate throughput. There is therefore a need in the art for multiplexing variable-rate data with data services on a shared channel.

### SUMMARY

Embodiments disclosed herein address the need in the art for multiplexing variable-rate data with data services on a shared channel. In one aspect, data from data services is prioritized. High priority data awaiting transmission may result in a dim command being issued to reduce the rate of the variable-rate data, thus making room for the data services data. Lower priority data from data services may wait for the next available space, without reducing the rate of the variable-rate data. In another aspect, data services data is categorized into three or more priority levels. High priority data can preempt variable-rate data. Medium priority data may result in a dim command reducing the variable-rate data. Low priority data may wait for the next available space, without reducing the rate of the variable-rate data. Various other aspects are also presented. These aspects have the benefit of allowing variable-rate and data services data to be multiplexed on a shared channel, while balancing the quality of the variable-rate data signal and maintaining data services when the variable-rate data is at a high rate.

The invention provides methods and system elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a general block diagram of a wireless communication system capable of supporting a number of users;

FIG. 2 depicts an exemplary embodiment of a mobile station;

FIG. 3 details an exemplary embodiment of a portion of a mobile station that prepares data for transmission;

FIG. 4 is a flowchart of an exemplary embodiment of a method for multiplexing various sublayers;

FIG. 5 depicts a prior art implementation of arbitration between data service data and variable-rate data;

FIG. 6 is a flowchart of an exemplary embodiment of arbitration which gives data service priority over variable-rate data;

FIG. 7 is a flowchart of an alternate embodiment of arbitration which balances variable-rate and data services by giving only a subset of data service frames priority over variable-rate data; and

FIG. 8 is a flowchart of an alternate embodiment of arbitration which balances variable-rate and data services by further prioritizing data service frames, allowing certain frames to preempt variable-rate data.

### DETAILED DESCRIPTION

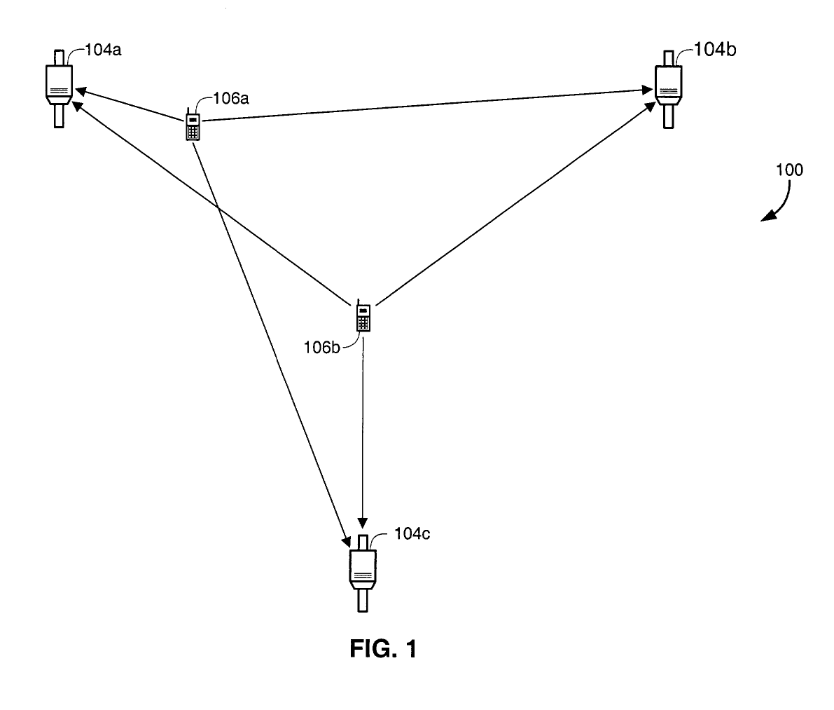

FIG. 1 is a diagram of a wireless communication system 100 that may be designed to support one or more CDMA standards and/or designs (e.g., the W-CDMA standard, the IS-95 standard, the cdma2000 standard, the HDR specification). For simplicity, system 100 is shown to include three base stations 104 in communication with two mobile stations 106. The base station and its coverage area are often collectively referred to as a “cell”. In IS-95 systems, a cell may include one or more sectors. In the W-CDMA specification, each sector of a base station and the sector's coverage area is referred to as a cell. As used herein, the term base station can be used interchangeably with the terms access point or NodeB. The term mobile station can be used interchangeably with the terms user equipment (UE), subscriber unit, subscriber station, access terminal, remote terminal, or other corresponding terms known in the art. The term mobile station encompasses fixed wireless applications.

Depending on the CDMA system being implemented, each mobile station 106 may communicate with one (or possibly more) base stations 104 on the forward link at any given moment, and may communicate with one or more base stations on the reverse link depending on whether or not the mobile station is in soft handoff. The forward link (i.e., downlink) refers to transmission from the base station to the mobile station, and the reverse link (i.e., uplink) refers to transmission from the mobile station to the base station.

For clarity, the examples used in describing this invention may assume base stations as the originator of signals and mobile stations as receivers and acquirers of those signals, i.e. signals on the forward link. Those skilled in the art will understand that mobile stations as well as base stations can be equipped to transmit data as described herein and the aspects of the present invention apply in those situations as well. The word “exemplary” is used exclusively herein to mean “serving as an example, instance, or illustration.” Any embodiment described herein as “exemplary” is not necessarily to be construed as preferred or advantageous over other embodiments.

System 100 provides the option of a mobile station 106 communicating with one or more base stations 104 using voice and data simultaneously. In the exemplary cdma2000 system, a mobile station 106 can communicate using the fundamental channel (FCH) as well as a supplemental channel (SCH). Voice is an example of a variable-rate data source that requires relatively low latency, but can tolerate loss of a certain percentage of packets while providing acceptable quality. Voice is delivered on the fundamental channel.

Signaling required to maintain the wireless connection (i.e. keep the call alive) is also transmitted on the fundamental channel. An example of this signaling is Layer 3 signaling. Examples of Layer 3 tasks include call setup, call release, handshaking, and call maintenance. In certain systems, cdma2000 for example, Layer 3 signaling should be given very high priority since it is required to maintain the communication link.

Data services are also provided. The data service protocol, TCP/IP for example, may allow for data retransmit and packet reordering, and, depending on the application, may accommodate a wide variation in latency. However, in contrast to variable-rate data like voice or video, the data service is generally intolerant of data loss. A user may want a minimum guarantee of service (GOS) or quality of service (QOS), which may be contracted between users and carriers in a wireless system, to ensure that a minimum average throughput, or other quality metric, is obtained.

Data systems commonly employ the Internet Protocol (IP) to facilitate data transfer. Systems employing IP send data in packets, and rely on the layer below IP, the link layer, to keep track of packet framing—that is, the start and end of each IP packet. Some CDMA systems, such as those employing the IS-95 standard, run IP on the Point-to-Point Protocol (PPP). PPP, in turn, uses a framing protocol named High Data Link Control (HDLC). For more information on using HDLC for PPP, see IETF RFC 1662.

In addition to utilizing a framing protocol, such as HDLC, PPP may run on a lower level protocol. For example, cdma2000 systems run PPP over Radio Link Protocol Type 3, hereinafter RLP. For details on RLP, reference TIA/EIA/IS-707-A-2.10, “Data Service Options for Spread Spectrum Systems: Radio Link Protocol Type 3.” (the RLP standard). In the exemplary embodiment, data services are delivered via RLP. Data service data may be referred to herein as RLP data. In general, RLP data has the characteristics described above, including latency tolerance, and the like. However, certain RLP control frames may need to be delivered with less latency than general packet data service in order to set up, maintain, or obtain adequate throughput for a data service session. Examples of this are detailed further below.

In cdma2000 systems, a portion of the control signaling required for data services is transmitted on the fundamental channel, the remainder is transmitted on the supplemental channel. For details on cdma2000 data services, see generally the TIA/ELA/IS-707 family of documents, “Data Service Options for Spread Spectrum Systems.”

Thus, in the exemplary system 100 (cdma2000), Layer 3 signaling, variable-rate data (voice), and data services (RLP data) are multiplexed onto the fundamental channel. In this example, the supplemental channel is not used for variable-rate data, so it will not factor into the following discussion. However, the principles disclosed herein would apply if variable-rate data were also multiplexed onto the supplemental channel, or any other channels. Those of skill in the art will recognize that the principles disclosed herein apply to any system including a channel on which variable-rate data, such as voice or video, must be multiplexed onto a channel with other data services, such as IP.

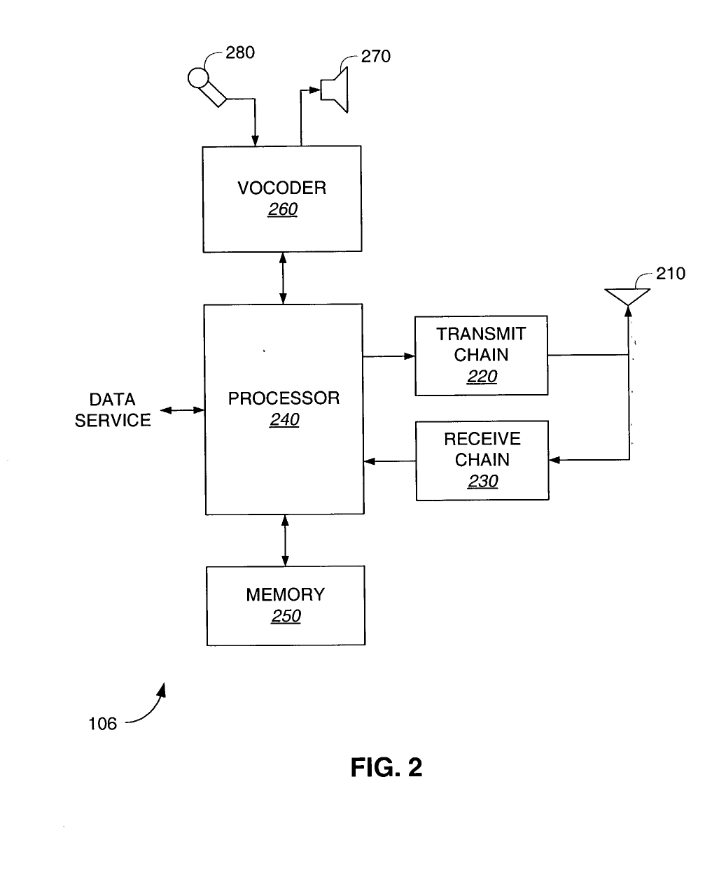

FIG. 2 depicts a portion of an exemplary mobile station 106. Signals are received and transmitted via antenna 210. Transmitted signals are formatted in transmit chain 220 according to one or more wireless system standards, such as those listed above, deployed in system 100. Examples of components that may be included in transmit chain 220 are encoders, interleavers, spreaders, modulators of various types, amplifiers, filters, digital-to-analog (D/A) converters, radio frequency (RF) converters, and the like. Data for transmission is provided to transmit chain 220 by processor 240. In the exemplary embodiment, processor 240 provides frames of data for transmission.

Signals received at antenna 210 are processed in receive chain 230 according to one or more wireless system standards, such as those listed above, deployed in system 100. Examples of components that may be deployed in receive chain 230 include RF downconverters, amplifiers, filters, analog-to-digital (A/D) converters, demodulators, RAKE receivers, combiners, deinterleavers, decoders (Viterbi, turbo, block decoders such as BCH, etc.), and others. Data from receive chain 230 is delivered to processor 240.

Some or all of the functions of receive chain 230 and transmit chain 220 may also be carried out in processor 240, or another processor such as a Digital Signal Processor (DSP) or other general or special purpose processor. Techniques for receiving and transmitting CDMA and other system samples and demodulating/decoding or encoding to produce data symbols are known in the art, and fall within the scope of the present invention. Those of skill in the art will recognize myriad combinations of these and other components that can be deployed without deviating from the principles of the invention disclosed herein.

In alternate embodiments, processor 240 may be a Digital Signal Processor (DSP) or any general-purpose processor. Those of skill in the art will recognize that the methods and functions described herein with respect to processor 240 can also be performed using special purpose hardware, co-processors, a combination of processors or DSPs, or a combination of all of the above. Some or all of the functions attributed to various other blocks described may also be carried out in processor 240. Processor 240 will commonly contain, or be connected with, one or more memory elements 250 for storing instructions to carry out the various tasks and processes described herein as well as data storage.

Vocoder 260 is the exemplary variable-rate data source, connected to processor 240. Other variable-rate data sources can also be deployed. Vocoder 260 receives voice from microphone 280 and, based on voice activity generates variable-rate data in response. In the exemplary embodiment, the vocoder produces full, half, quarter, and eighth rate frames. Full rate frames are produced when the voice activity is high. When the user is listening rather than speaking, eighth rate frames may be generated to provide an indicator of background noise. Any number of rates can be supported within the scope of the present invention. A vocoder is also commonly used for decoding received (and demodulated via receive chain 230) vocoded data to produce an audio signal representative of the voice signal which can be delivered for audio reproduction on speaker 270.

Processor 240 also receives and delivers data service data, which may be IP data, as described above, or any other type of data service. Common examples of components for which data service is provided would be a laptop computer connected to mobile station 106, or mobile station 106 comprising a personal data assistant (PDA) or other such device, or another device such as a PCMCIA card.

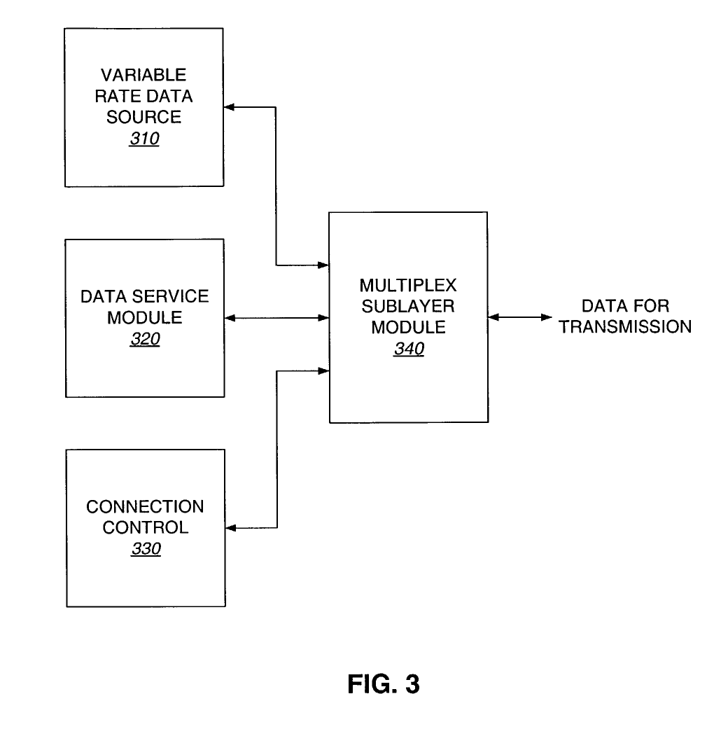

FIG. 3 details an exemplary embodiment of a portion of a mobile station 106 that prepares data for transmission, such as with transmit chain 220. The blocks can be carried out as software modules in processor 240, as discrete hardware components, with one or more coprocessors (i.e. vocoder 260), or a combination of all of the above. Instructions and data for processing the modules may be stored in a memory such as memory 250.

Mulitiplex sublayer module 340 polls the connected blocks, variable-rate data source 310, data service module 320, and connection control 330, to determine if one or more of the blocks have data for transmission. These three blocks are exemplary only, as any number of data sources could be deployed, with myriad data types for each source. Multiplex sublayer module 340 receives data, which may or may not be framed data, and produces data for transmission in the format required for transmit chain 220. In the exemplary embodiment, the output of multiplex sublayer module 340 comprises frames of data. Data from any of the three sources may require less than one frame, or multiple frames for complete transmission. Multiplex sublayer module 340 takes partial frames and combines them to form full frames when applicable, and parses larger sets of data into multiple frames. Multiplex sublayer module 340 assembles data from one or more logical channels into a form suitable to be sent out on the physical layer.

In the exemplary embodiment, when a voice call is active, the variable-rate data source 310 will always have a frame for transmission. When the frame is a full-rate frame, there is no room for data from the other modules. When it is half rate or less, control frames from the RLP controller can be multiplexed with the voice frame and transmitted simultaneously. When voice and data are occurring simultaneously, the availability of RLP data for transmission may be sporadic.

When variable-rate data source 310 is polled, it returns an indication of data available for transmission as well as a rate indicator. Exemplary rates were described with respect to vocoder 260 above. In some embodiments disclosed herein, a dim command can be issued to variable-rate data source 310, which will cause the variable-rate data source to temporarily cap the amount of data generated. In the exemplary embodiment a dim command will cause the vocoder to produce, at most, half-rate data for one frame. There can be a delay of one or two frames for a dim command to take effect. If the vocoder would have otherwise produced full-rate data based on voice activity, the dim command will cause a reduction in rate. A dim command issued when the vocoder would not have otherwise produced full-rate data will have no effect. Naturally, voice quality may be affected when the frequency of dim commands increases, assuming a corresponding increase in actual rate reduction. Those of skill in the art will recognize how to apply dim commands to any variable-rate data source. Dim commands are not restricted to reducing full rate data to half-rate. Alternate embodiments may provide dim commands that allow any type of control over the rate generated.

Data service module 320 provides an indication of data available, when polled, and can also provide an indicator of what type of data is available. As will be described in further detail below, control frames from data service module 320 may need to be treated differently than general payload data, due to differing latency requirements, for example. In the exemplary embodiment, data service module 320 is an RLP controller.

Connection control 330 is an exemplary data source. In the exemplary embodiment, connection control 330 is a Layer 3 signaling source, as described above. Layer 3 signaling is deemed to be the highest priority, due to the assumption that such data is necessary to keep the communication link alive. When polled, if data is available for transmission from connection control 330, it is transmitted right away without regard to the contents of the data. Alternate systems may not require such a connection control 330, or have a data source whose data is of such high priority. In such a case, the arbitration schemes described below will be readily extended by those of skill in the art to the data from connection control 330. For the sake of clarity of the following discussion, connection control 330 (or Layer 3 signaling) is used as an example of a preemptive data source only.

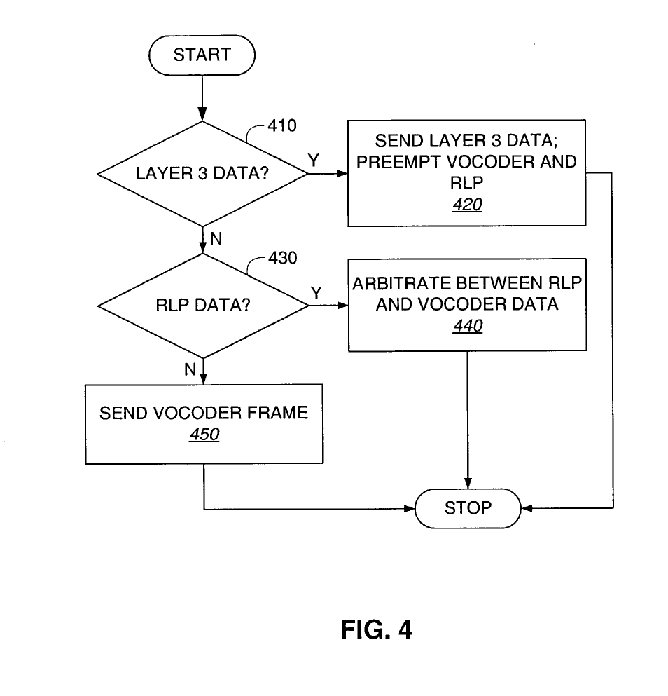

FIG. 4 is a flowchart of an exemplary embodiment of a method for multiplexing the various sublayers from the components described with respect to FIG. 3. This flowchart uses the exemplary Layer 3 data for connection control and RLP data for data services. The variable-rate data source is assumed to be a vocoder and a voice session is active so the vocoder will produce at least an eighth rate frame each iteration. The process can be repeated to produce each output frame from multiplex sublayer module 340. Those of skill in the art will readily generalize this exemplary flowchart to the components as described in FIG. 3.

In the exemplary embodiment, in service profile VP1 (see the cdma2000 standard), simultaneous voice and data (SVD) services can be supported via the fundamental channel (FCH) and the supplemental channel (SCH). In this case the multiplex sublayer module needs to multiplex RLP control frames with Layer 3 signaling and voice data on the reverse fundamental channel (R-FCH). In certain circumstances, some data frames are more important than others in providing SVD services. An efficient method to multiplex the R-FCH traffic data is necessary for at least two purposes: 1) keeping the voice and data services alive; and 2) maximizing the data throughput with minimal impact on voice quality. FIG. 4 depicts the outline of this process.

The process starts in decision block 410, where the connection control 330 is polled to see if any Layer 3 data is available for transmission. If so, proceed to step 420, and send the Layer 3 data straight away. Any available vocoder or RLP data will be preempted. Then the process stops. If no Layer 3 data is present, proceed to decision block 430.

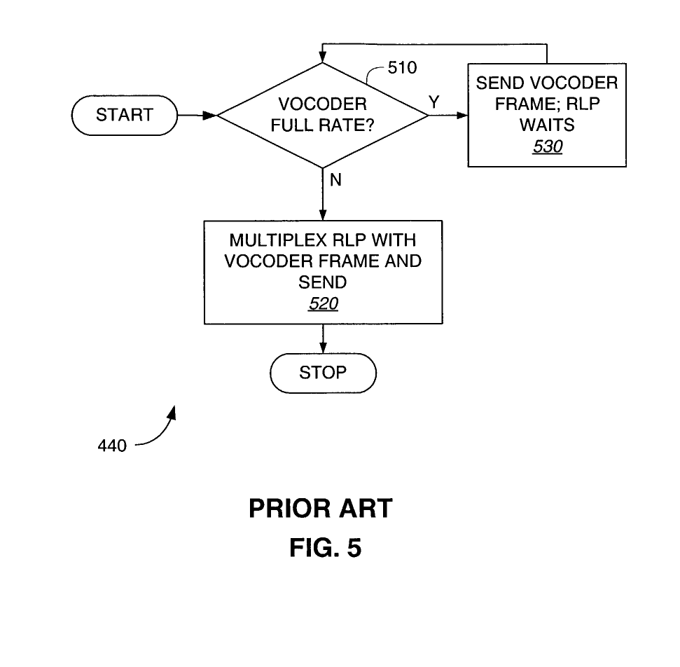

In decision block 430, the data service module 320 is polled to see if any RLP is available for transmission. If so, proceed to step 440 to arbitrate between the RLP data and the vocoder data (recall that vocoder data is presumed available since a voice call is active). Various embodiments of step 440 arbitration are detailed below with respect to FIGS. 5-8. Note that, as described above, the arbitration methods 440 detailed below could also be applied in step 420 if connection control data was not presumed to be preemptive. Once the arbitration and resultant data has been sent in step 440, the process stops. If no RLP data is present, in decision block 430, proceed to step 450 and send the vocoder frame. Then the process stops. Note that this process can be repeated to produce each frame of data output from multiplex sublayer module 340 (or other increment of data in alternate embodiments not utilizing frames).

FIG. 5 depicts a prior art implementation of the arbitration between data service data, such as RLP, and variable-rate data, such as voice. This is one implementation of step 440 of FIG. 4. In this implementation, voice is multiplexed with RLP data by giving priority to voice. RLP data that is queued must wait until the voice activity produces half-rate or lower data so that the RLP data can be inserted into the voice frames. (The connection is maintained, through Layer 3, for example, by giving Layer 3 signaling priority over voice.) Thus RLP control frames have a chance to be sent only when there are no Layer 3 messages and the voice rate is less than full rate. The process begins in decision block 510. If the vocoder data is at full rate, proceed to step 530 to send the vocoder frame. The RLP data must wait. Proceed back to decision block 510 until the vocoder produces data at less than full rate. When that occurs, proceed to step 520, where the RLP data is multiplexed with the vocoder data and sent. Then the process stops.

Using the technique of FIG. 5, in certain circumstances, for example when the voice activity is high, data service may not be established, or the data throughput may be extremely low. This scheme allows voice data to be transferred with minimal interruption, but the data services may not be sufficient to meet certain QOS requirements.

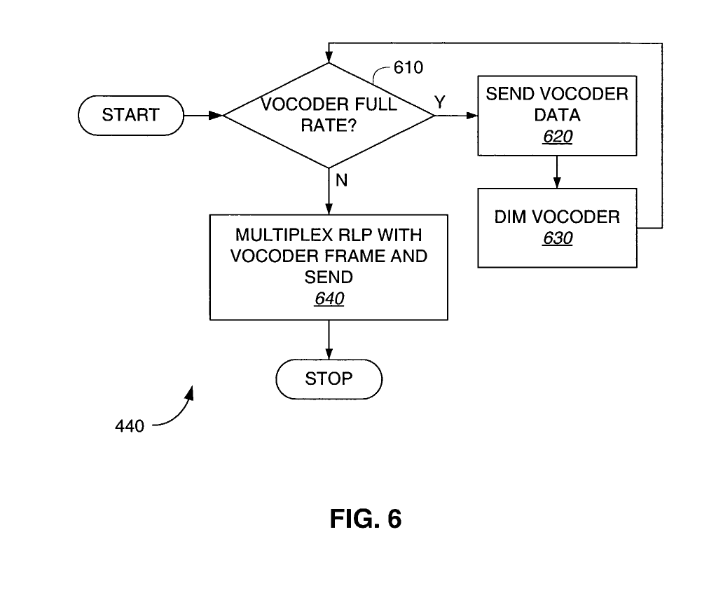

FIG. 6 is a flowchart of an exemplary embodiment of arbitration step 440 which gives RLP (data service) priority over voice (variable-rate data). The process begins in decision block 610. Recall that step 440 occurred subsequent to the determination that RLP data was available for transmission. Recall also that a voice call is active, so a vocoder frame is produced during each multiplex sublayer module 340 output frame. If the vocoder data is full rate, proceed to step 620 to send the vocoder frame. Then proceed to step 630 to dim the vocoder to half-rate. Proceed to step 610 to test the vocoder data rate. In certain implementations, there may be a delay between the issuance of a dim command and the subsequent reduction of data rate. In such a case, the vocoder rate may still be full and the process may return to step 620 to send the vocoder data. Then proceed to step 630 to send another dim command. This is useful if the RLP data is likely to take more than one frame (as each dim command in the exemplary embodiment dims the vocoder for one frame—multiple dim commands produce multiple dimmed frames). In an alternate embodiment, a second dim command will not be issued if the RLP data has not been sent and the first dim command has been queued. In either alternative, in decision block 610, if the vocoder rate is less than full rate (whether naturally occurring due to voice activity or in response to a dim command), proceed to step 640. In step 640, multiplex the RLP data with the vocoder data and send the resultant frame. Then the process stops.

In another alternative, the dim command can be issued before checking the vocoder rate (recall that in step 440, there is RLP data waiting to be sent), then the RLP data waits for a frame in which it can be multiplexed. Note that a dim command is ignored if the data is already less than full rate. In this alternative, when the first vocoder frame is less than full rate, and so the RLP data could have been immediately multiplexed, the dim command will have already been sent, possibly resulting in unnecessary reduction in vocoder rate. This alternative may be useful when RLP data tends to come in bursts of multiple frames (and hence the dim command will likely be useful regardless of the current state of the vocoder rate).

In the embodiment of FIG. 6, and the alternatives described, RLP data is given priority over voice, since voice is dimmed whenever RLP data is present. This may have negative impact on voice quality in certain circumstances, since this method treats all types of RLP data with equal importance and may reduce the maximum vocoder rate before even testing if the RLP data would fit in to the frame being built. In a typical voice call, about 30% of the frames are full rate and about 60% of the frames are eighth rate. Thus, RLP frames usually have a high probability of getting through without being given special consideration over voice. Only in situations where the vocoder generates an unusually large percentage of full rate frames (high voice activity or loud background noise, for example), is the multiplex sublayer module 340 required to make room for the RLP frames.

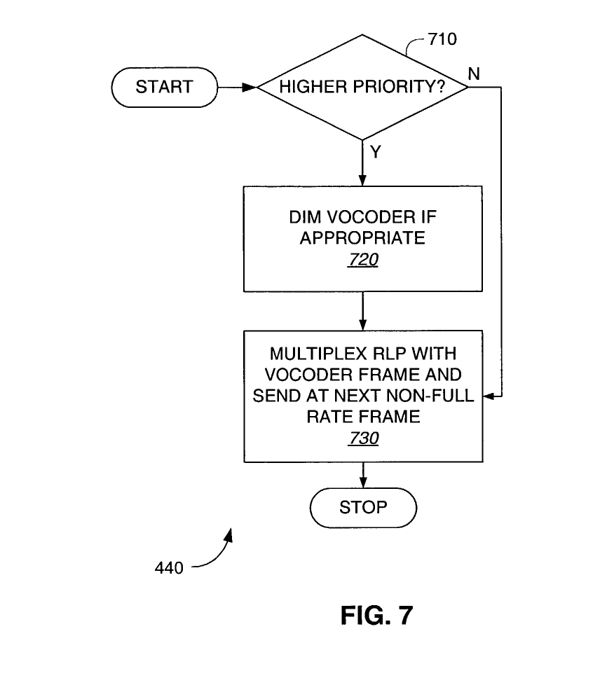

FIG. 7 is a flowchart of an alternate embodiment of arbitration step 440 which balances voice and data by giving only a subset of RLP (data service) frames priority over voice (variable-rate data). Certain RLP frames, such as control frames needed to maintain the data connection, are categorized as higher priority. Other RLP frames are designated as lower priority. The process begins in decision block 710. If the RLP data is higher priority, proceed to step 720 and dim the vocoder if necessary. The vocoder may not need to be dimmed if it is already at less than full rate and the RLP frame fits within the vocoder data. If the vocoder is at full rate, or if multiple frames will be needed for the RLP data, then the vocoder should be dimmed for the appropriate number of frames. Proceed to step 730, where, at the next available frame, the RLP data will be multiplexed with the vocoder data (there may be a delay if the dim command takes effect delayed from the time of issuance). If, in decision block 710, the RLP data is not higher priority, then proceed to step 730 and wait for the next available frame. No dim command will be issued, and the voice data will not be limited. Once the RLP data has been transmitted, the process stops.

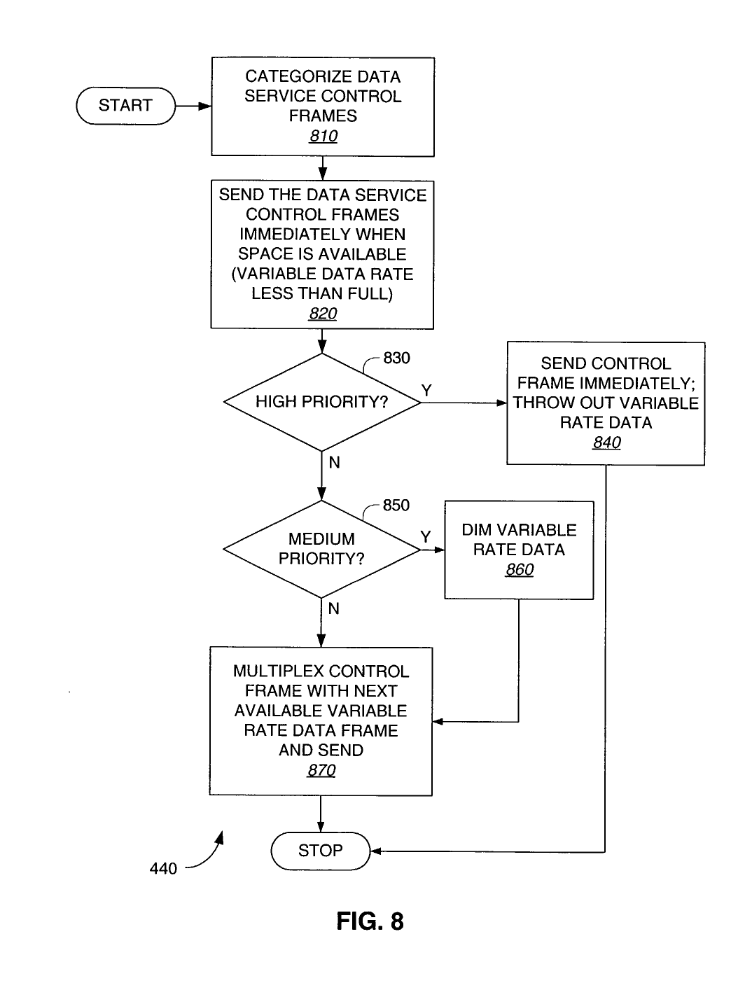

Note that this embodiment provides a means for getting RLP data through even during times of unusually high full-rate vocoder data. Note also that vocoder data is not thrown out (as will be described with respect to FIG. 8), so voice quality is reduced minimally. However, there is still a potential latency involved in getting RLP data out, due to the delay between the dim command and the subsequent rate reduction. For certain RLP frames, notably the Sync and Sync Ack frames, this delay is unacceptable for the purpose of computing round trip delay. This is important because RLP throughput will be reduced if the round trip delay calculation is too long. As mentioned above, reduced throughput may not interfere with voice communications, but it may provide a level of service that is unacceptable to the mobile station user.

FIG. 8 is a flowchart of an alternate embodiment of arbitration step 440 which balances voice and data by further prioritizing RLP (data service) frames, allowing certain RLP frames to preempt voice (variable-rate data), thus reducing latency for that class of RLP frames. The process starts in step 810, in which the data service control frames are categorized according to priority. Note that control frames are an exemplary class of frames for categorization, any data service frames can be given any priority desired (in the exemplary embodiment, the bulk of data is transmitted on the supplemental channel). In the exemplary embodiment, there are three categorizations: high, medium, and low. Table 1 describes some RLP frames, their usage, frequency, rate, and an exemplary priority ranking. Such a ranking could be devised in step 810. Myriad other combinations are also contemplated. Note that step 810 is shown as part of the flowchart for clarity, but is not part of arbitration step 440. The categorization may need to be performed once during the design phase of a mobile station 106. Steps 820-870 can be substituted for arbitration step 440 to perform arbitration according to the prioritization developed in step 810. Proceed to step 820.

TABLE 1

| RLP | | | | |
|---|---|---|---|---|
| Frame | Usage | Frequency | Rate | Priority |
| Sync/Sync | To establish the call or | Rare | ¼ | High |
| Ack Frames | re-synchronize the link. | | | |
| | Also used to calculate | | | |
| | RTT (minimum delay | | | |
| | allowed in sending | | | |
| | these frames). | | | |
| NAK Frames | To inform the base | Dependent on | ⅛-½ | Medium |
| | station of missing data | Forward Error | | |
| | | Rate (FER) | | |
| Idle Frames | To keep the link alive | Implementation | ⅛ | Low |
| | | dependent | | |
| | | (Example: sent | | |
| | | once every 6 | | |
| | | frames when there | | |
| | | are no data to | | |
| | | send) | | |
| Fill Frames | To maintain | Implementation | ⅛ | Low |
| | synchronization with | dependent | | |
| | the base station | (Example: once | | |
| | | every 80 frames | | |
| | | when there are no | | |
| | | data to send) | | |
| Re- | To re-send the missing | Dependent on FER | Variable | Very Low, |
| transmitted | data NAKed by the | and SCH rate | | especially |
| Data Frames | base station | | | when R-SCH |
| | | | | is assigned |

In step 820, data control frames are sent immediately when the variable data rate is less than full. In an alternative embodiment, data control frames are sent immediately when the variable data rate is low enough to allow the entire control frame to be sent in one multiplexed frame. (The process can terminate when this is the case, not shown.) Proceed to decision block 830. If the data service control frame is high priority, proceed to step 840. In step 840, send the control frame immediately. The variable-rate data is thrown out. In addition, in step 840, if more than one high priority frame will be sent consecutively, a dim command can be issued such that subsequent variable-rate data need not be thrown out, but at least partial rate data will go out in the next frame. The process stops once the high priority data is sent.

If, in decision block 830, the data control frame was not high priority, proceed to decision block 850. If the data control frame is medium priority, proceed to step 860. In step 860, dim the variable-rate data (for example, as described above with respect to FIGS. 6 and 7) and proceed to step 870. In step 870, the control frame is muiltiplexed with the variable-rate data in the next available frame and sent. For medium priority control frames, there may be a delay from the dim command to the time space is avilaable in a variable-rate data frame. The process stops once the medium priority data is sent.

If, in decision block 850, the data service control frame was not medium priority, then it is low priority. Without dimming, proceed to step 870 and wait for the next available space, as just described. Once the low priority data is sent, the process stops.

In the exemplary embodiment, in a cdma2000 system, the technique shown in FIG. 8 allows RLP data to be sent out immediately when the vocoder frame rate is less than full. When the vocoder data frame rate is full, RLP frames categorized as high priority are sent out immediately, throwing away the vocoder data. Thus, delay sensitive RLP frames like Sync/Sync Ack are given higher priority than voice frames. Since Sync/Sync Ack frames will arrive consecutively, once one is received, the multiplex sublayer module 340 can dim the vocoder rate to half for the next frame (as described in step 840 above). Alternatively, if the dim command is not given, the subsequent high priority data will simply preempt the vocoder data and it will be thrown out.

Medium priority frames will be sent out with a certain maximum delay by reducing the vocoder rate with the dim commands. For example, NAK frames will be sent out typically with a 2 to 3 frame delay (when the vocoder rate is consistently full).

Low priority frames are sent out only when the vocoder frame rate drops below full. Therefore, for example, idle, fill, and re-transmitted data frames are sent out only when they fit into unused space by the voice data.

Those of skill in the art will recognize that the flowchart of FIG. 8 is a generalized method that contains portions of methods described with respect to FIGS. 5-7. By removing steps 830-860 and proceeding from step 820 to 870, the voice priority method of FIG. 5 is generated. By removing steps 830-850 and proceeding from step 820 to step 860, the RLP priority method of FIG. 6 is generated. By removing steps 830-840 and proceeding from step 820 to step 850, the two-level categorizing method of FIG. 7 is generated. Note that other two-level categorizing schemes other than that of FIG. 7 can be deployed. FIG. 7 depicts a two-level scheme using the medium and low categories described in FIG. 8. Other alternatives include using the high and medium categories (and their corresponding responses as described in FIG. 8) or the high and low categories only. FIG. 8 expanded on the previous figures with a three level categorization. Additional levels of categorization can also be supported. For example, a variable dim command (that would allow dimming to more than one maximum rate) would allow for more or less available space in future frames, thus allowing for additional priority classifications of data service frames. These and other modifications will be readily adaptable by those of skill in the art and fall within the scope of the present invention.

Note that the foregoing discussion has used the signals, codes and parameters defined in the cdma2000 standard as some of the exemplary signals, codes and parameters. This is for clarity of discussion only, and should not be construed to limit the scope of the present invention to cdma2000 systems. The principles of the present invention apply to any conceivable system in which variable-rate data is to be multiplexed with data with different characteristics (including but not limited to varying latency requirements), as described above. Those skilled in the art will recognize how to adapt the various embodiments described for use with such alternate systems.

It should be noted that in all the embodiments described above, method steps can be interchanged without departing from the scope of the invention.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
a multiplex sublayer module for receiving a first variable-rate data stream and a second data stream, forming a third data stream from the first and second data streams, and generating a dim command to reduce the rate of the first variable-rate data stream to make room for a portion of the second data stream in the third data stream.

2. The apparatus of claim 1, wherein the dim command is generated whenever the first variable-rate data stream is at full rate and data from the second data stream is waiting for transmission.

3. The apparatus of claim 1, wherein:
the second data stream comprises higher and lower priority data; and
the dim command is generated whenever the first variable-rate data stream is at full rate and higher priority data from the second data stream is waiting for transmission.

4. The apparatus of claim 1, wherein:
the second data stream comprises higher and lower priority data;
variable-rate data is discarded when higher priority data from the second data stream is waiting for transmission and there is not space in the third data stream, allowing for immediate transmission of the higher priority data; and
the dim command is generated whenever the first variable-rate data stream is at full rate and lower priority data from the second data stream is waiting for transmission.

5. The apparatus of claim 1, wherein:
the second data stream comprises higher and lower priority data;
variable-rate data is discarded when higher priority data from the second data stream is waiting for transmission and there is not space in the third data stream, allowing for immediate transmission of the higher priority data; and
lower priority data from the second data stream wait for space in the third data stream in accordance with a rate reduction in the variable-rate data stream.

6. The apparatus of claim 1, wherein:
the second data stream comprises data categorized into three or more levels of priority;
variable-rate data is discarded when high priority data from the second data stream is waiting for transmission and there is not space in the third data stream, allowing for immediate transmission of the high priority data;
the dim command is generated whenever the first variable-rate data stream is at full rate and medium priority data from the second data stream is waiting for transmission; and
low priority and medium priority data from the second data stream wait for space in the third data stream in accordance with a rate reduction in the variable-rate data stream.

7. The apparatus of claim 1, further comprising a variable-rate data source.

8. The apparatus of claim 1, wherein the variable-rate data source is a vocoder.

9. The apparatus of claim 1, wherein the variable-rate data source is a video encoder.

10. The apparatus of claim 1, further comprising a data service module.

11. The apparatus of claim 6, wherein the data service module is an RLP controller.

12. The apparatus of claim 6, wherein the high priority data category comprises Sync frames.

13. The apparatus of claim 6, wherein the high priority data category comprises Sync Ack frames.

14. The apparatus of claim 6, wherein the medium priority data category comprises NAK frames.

15. The apparatus of claim 6, wherein the low priority data category comprises idle frames.

16. The apparatus of claim 6, wherein the low priority data category comprises fill frames.

17. The apparatus of claim 6, wherein the low priority data category comprises re-transmitted data frames.

18. A wireless communication device comprising:
a multiplex sublayer module for receiving a first variable-rate data stream and a second data stream, forming a third data stream from the first and second data streams, and generating a dim command to reduce the rate of the first variable-rate data stream to make room for a portion of the second data stream in the third data stream.

19. A wireless communication system, including a wireless communication device, comprising:
a multiplex sublayer module for receiving a first variable-rate data stream and a second data stream, forming a third data stream from the first and second data streams, and generating a dim command to reduce the rate of the first variable-rate data stream to make room for a portion of the second data stream in the third data stream.

20. A method of multiplexing data streams, comprising:
issuing a dim command to reduce the rate of a first variable-rate data stream to make room for a portion of a second data stream in a third data stream.

21. A method of multiplexing data streams, comprising:
sending high priority data from a second data stream immediately, discarding data from a first variable-rate data stream if its rate is too high to accommodate the high priority data.

22. A method of multiplexing a variable-rate data stream with a second data stream comprising data categorized as higher or lower priority, the method comprising:
issuing a dim command to reduce the rate of the variable-rate data if its rate is too high to accommodate the higher priority data; and
waiting for the next available opportunity to transmit data from the second data stream in accordance with the rate of the variable-rate data.

23. A method of multiplexing a variable-rate data stream with a second data stream comprising data categorized as high, medium or low priority, the method comprising:
sending high priority data from the second stream immediately, discarding the variable-rate data if its rate is too high to accommodate the high priority data;
issuing a dim command to reduce the rate of the variable-rate data if its rate is too high to accommodate the medium priority data; and
waiting for the next available opportunity to transmit medium or low priority data in accordance with the rate of the variable-rate data.

24 An apparatus, comprising:
means for issuing a dim command to reduce the rate of a first variable-rate data stream to make room for a portion of a second data stream in a third data stream.

25 An apparatus, comprising:
means for discarding data from a variable-rate data stream when high priority data from a second data stream allowing for immediate transmission of the high priority data in a third data stream.

26 An apparatus, operable with a variable-rate data stream and a second data stream comprising data categorized as high, medium or low priority, the apparatus comprising:
means for sending high priority data from the second stream immediately, discarding the variable-rate data if its rate is too high to accommodate the high priority data;
means for issuing a dim command to reduce the rate of the variable-rate data if its rate is too high to accommodate the medium priority data; and
means for waiting for the next available opportunity to transmit medium or low priority data in accordance with the rate of the variable-rate data.

27. A wireless communication system, including a wireless communication device, operable with a variable-rate data stream and a second data stream comprising data categorized as high, medium or low priority, the wireless communication device comprising:
means for sending high priority data from the second stream immediately, discarding the variable-rate data if its rate is too high to accommodate the high priority data;
means for issuing a dim command to reduce the rate of the variable-rate data if its rate is too high to accommodate the medium priority data; and
means for waiting for the next available opportunity to transmit medium or low priority data in accordance with the rate of the variable-rate data.

28. Processor readable media operable to perform the following step:
issuing a dim command to reduce the rate of a first variable-rate data stream to make room for a portion of a second data stream in a third data stream.

29. Processor readable media operable to perform the following steps:
sending high priority data from a second data stream immediately, discarding data from a first variable-rate data stream if its rate is too high to accommodate the high priority data.

30. Processor readable media operable to perform the following steps:
sending high priority data from a second data stream immediately, discarding data from a first variable-rate data stream if its rate is too high to accommodate the high priority data;
issuing a dim command to reduce the rate of the first variable-rate data stream if its rate is too high to accommodate medium priority data from the second data stream; and
waiting for the next available opportunity to transmit medium or low priority data from the second data stream in accordance with the rate of the first variable-rate data stream.
